(19) United States
(12) Patent Application Publication
(10) Pub. No.: US 2025/0338887 A1
(43) Pub. Date: Nov. 6, 2025

(54) AEROSOL-GENERATING ARTICLE ASSEMBLY ON A CONVEYOR WITH A SPACER

(71) Applicant: Philip Morris Products S.A., Neuchatel (CH)

(72) Inventor: Fabio CANTIERI, Bologna (IT)

(73) Assignee: Philip Morris Products S.A., Neuchatel (CH)

(21) Appl. No.: 18/854,137

(22) PCT Filed: May 11, 2023
(86) PCT No.: PCT/EP2023/062608

§ 371 Date: Oct. 4, 2024

(30) Foreign Application Priority Data
May 11, 2022 (EP) 22172767.0

(51) Int. Cl. A24C 5/47; A24C 5/01; A24C 5/32; A24C 5/52; B23P 21/00

(52) U.S. Cl. CPC A24C 5/478; A24C 5/01; A24C 5/327; A24C 5/471; A24C 5/52; B23P 21/004

(57) ABSTRACT

An apparatus for assembling an aerosol-generating article, the apparatus including: a conveyor with a support surface configured to support at least two axially aligned rod-shaped segments of the aerosol-generating article; and a spacer, the apparatus being configured to move the spacer from a retracted position to an active position, in which the spacer provides an abutment means for the rod-shaped segments on the support surface, and the conveyor including the spacer. A method for manufacturing an aerosol-generating article is also provided.

The present invention relates to an apparatus for assembling an aerosol-generating article, a method for manufacturing an aerosol-generating article and a use of a spacer in an apparatus for manufacturing an aerosol-generating article.

WO2021123425A1 discloses a wrapping device and method for wrapping a sheet around a group of segments. In WO2021165509A1, an aerosol-generating article, wherein a rod and a filter are arranged in a spaced-apart relationship, and a manufacturing method therefor are shown.

There is a need for improving the assembly of aerosol-generating articles having a gap between a rod and a filter.

According to a first aspect of the invention, there is provided an apparatus for assembling an aerosol-generating article. The apparatus comprises a conveyor with a support surface for supporting at least two axially aligned rod-shaped segments of the aerosol-generating article. The apparatus further comprises a spacer. The apparatus is configured to move the spacer from a retracted position to an active position. In the active position, the spacer provides an abutment means for the rod-shaped segments on the support surface.

In particular, the spacer provides an abutment means for two rod-shaped segments arranged on opposite sides of the spacer in the active position.

The apparatus may comprise several aligned spacers. The several aligned spacers may be alternatingly arranged with several axially aligned rod-shaped segments. In particular, the apparatus may comprise two aligned spacers. The two aligned spacers may be alternatingly arranged with three aligned rod-shaped segments.

In the active position, the spacer may be arranged between the rod-shaped segments, in particular such that the rod-shaped segments may not be in contact with each other. Moving the spacer into the retracted position may provide a gap between the two rod-shaped segments. The gap between the rod-shaped segments may result in less material of the rod-shaped segments used. Thus, the apparatus may reduce material costs and increase sustainability. With the apparatus, an aerosol-generating article with a gap between two rod-shaped segments may be formed with less process steps compared to conventional methods.

The aerosol-generating article may be a combustible cigarette or an article used in a heat-not-burn device. One of the rod-shaped segments may be an aerosol-generating rod. The aerosol-generating rod may contain an aerosol-generating substrate, in particular tobacco, herbs, oil or an artificial substrate. One of the rod-shaped segments may be a filter or hollow tube, in particular made of acetate tow, such as a cigarette filter. A consumer may consume the aerosol-generating article by combustion. During combustion, the aerosol-generating rod may burn and the burning area of the aerosol-generating rod may come in close proximity to the filter. This may cause burning or excessive heating of the filter, which may negatively affect the taste of the smoke. The gap between the filter and the rod may prevent such an effect. In heat-not-burn devices, where the aerosol-generating article may be heated rather than burned, the aerosol-generating rod may be heated to about 300 degrees Celsius or more, the space between the aerosol-generating rod and the filter may advantageously provide a space in which the aerosol can cool, condense, and nucleate before passing through the filter into a user's mouth.

The conveyor may comprise the spacer. The conveyor may comprise a storing cavity to house the spacer, at least when the spacer is in the retracted position. The storing cavity may have substantially the same size as the spacer. The storing cavity may be bigger as the spacer, such that the storing cavity may house other components in addition to the spacer.

In the retracted position, the spacer may be flush or below the support surface. Such a configuration may enable that a sheet, in particular a wrapper, may be wrapped around the rod-shaped segments without interfering with the spacer. In the active position, the spacer may protrude from the support surface.

A plunger or guide surface may be provided to push one or both rod-shaped segments against the spacer in the active position. The guide surface may be stationary. The stationary guide surface may extend at least partially along the circumference of the drum, wherein the stationary guide surface may be inclined with respect to the axial direction. The rod-shaped segments may be moved against the guide surface, such that the guide surface forces the rod-shaped segments against the spacer. The plunger or guide surface may engage the distal end of the rod-shaped segment, while the proximal end of the rod-shaped segment comes in contact with the spacer. As an alternative to a guide surface or a plunger, the rod-shaped segments may be pushed against the spacer by means of air pressure. The apparatus may comprise an air nozzle. The air nozzle may be adapted to apply an air pressure to a rod-shaped segment or the rod-shaped segments, such that the rod-shaped segment or the rod-shaped segments are pushed against the spacer.

The spacer may have a width of 1 millimeter to 15 millimeters, in particular 1 millimeter to 4 millimeters. Such a value may provide a sufficiently large gap between the rod-shaped segments. The width of the spacer may correspond to the gap that is formed between the rod-shaped segments, in particular the distance between the rod-shaped segments. The width of the spacer may be measured in a longitudinal direction of the rod-shaped segments.

The conveyor may comprise a cam. The cam may be adapted to move the spacer from the retracted position to the active position. A cam may be an efficient and precise way to move the spacer. Such a system may require minimal maintenance. Such a system may require minimal control. The cam may be exchangeable to provide for different spacer movements.

The orientation or position or the orientation and position of the cam may be adjusted to adapt the spacer movement.

Alternatively, the spacer may be moved by a motor driven by an electronic controller.

The conveyor may comprise a drum. The drum may be adapted to rotate around a rotation axis. A drum may be an efficient tool to convey the rod-shaped segments and the aerosol-generating article.

The drum may comprise the spacer. The drum may be adapted to rotate relative to the cam, such that the spacer may be rotated around the cam. When the spacer passes the cam, the spacer may get in contact with the cam and may be moved into the active position. The cam may push the spacer into the active position. The spacer may be in contact with the cam around the entire rotation of the drum.

The cam may be stationary. The cam may be a desmodromic cam. The cam may be a magnetic cam.

The drum may be stationary and the cam may be adapted to rotate relative to the drum. When the cam is rotated, the cam may get in contact with the spacer and may move the spacer into the active position.

The drum may be adapted to rotate around a rotation axis. The cam may be adapted to rotate around a rotation axis. The drum and the cam may be adapted to rotate around the same rotation axis. The drum and the cam may rotate at different speeds. The drum and the cam may rotate in opposite directions. The drum and the cam may rotate in the same direction.

The conveyor may comprise a groove. The groove may form the support surface. The groove may be formed on the support surface. The groove may be adapted to receive the rod-shaped segments of the aerosol-generating article. The groove may facilitate holding the rod-shaped segments. The groove may facilitate axially aligning the rod-shaped segments.

The spacer may be arranged such that the spacer protrudes into the groove in the active position. This may allow to axially align the rod-shaped segments in the groove and arrange the rod-shaped segments in a distance to each other.

The storing cavity may open towards the groove. Thus, at least a part of the spacer may move into the groove.

The conveyor may comprise multiple grooves. The multiple grooves may be spaced around a circumferential surface, in particular the support surface, of the conveyor, in particular the drum. The grooves may be spaced equidistantly around the conveyor. The conveyor may comprise multiple spacers. The spacers may be spaced equidistantly around the conveyor. Each spacer may be associated with a groove. The conveyor may comprise multiple storing cavities. Each storing cavity may be associated with a groove, in particular arranged adjacent to the respective groove.

The apparatus may comprise a spring. The spring may be adapted to bias the spacer towards the retracted position. The cam may be adapted to move the spacer into the active position against the biasing force of the spring. When the spacer is rotated away from the cam or the cam is rotated away from the spacer, the spring may move the spacer into the retracted position. The spring may move the spacer back into the storing cavity. The spring may move the spacer flush with the support surface or below the support surface.

The spacer may comprise a flange. The flange may be adapted to engage with the spring.

The spring may be a compression spring. The spring may be arranged between a part of the spacer, in particular the flange, and the support surface. The spring may push the spacer into the storing cavity.

The spring may be a tension spring. The spring may be arranged between a part of the spacer, in particular the flange, and a center of the conveyor, in particular the drum. The spring may pull the spacer into the storing cavity.

The apparatus may comprise magnets. The magnets may be adapted to bias the spacer towards the retracted position. The cam may be magnetic, such that the spacer may be moved into the active position by magnetic force. The cam may change the direction of the magnetic force such that the spacer is moved into the retracted position. A magnet may keep the spacer in the retracted position. The magnet may be switched off such that the spacer may be moved to the active position due to centrifugal forces. The centrifugal forces may be caused due to a rotation of the conveyor or the drum. The magnet may be constantly active. A shielding element may be arranged between the magnet and the spacer at a predefined position, such that the spacer may not be affected by the magnet. In this position, the magnet may not bias the spacer into the retracted position and the spacer may be moved into the active position due to centrifugal forces. The shielding element may be a second magnet with a different orientation compared to the other magnet, such that the spacer may be moved into the active position by the second magnet. A magnet may be located outside of the drum or the conveyor and pull the spacer into the active position or push the spacer into the retracted position.

Suction holes may be provided in the support surface. The conveyor may comprise suction channels. The suction channels may open towards the support surface, in particular towards the suction holes. The suction holes may facilitate holding the rod-shaped segments. The suction holes may be provided in the groove on the support surface. The suction holes may be equidistantly spaced in the groove. The suction holes may be equidistantly spaced around the support surface. All suction holes may have substantially the same size. Suction holes with different sizes may be provided.

The apparatus may comprise a wrapper conveyor. The wrapper conveyor may be a drum adapted to rotate around a rotation axis. The wrapper conveyor may wrap a sheet around the rod-shaped segments.

The wrapper conveyor may be arranged adjacent to the conveyor. The rod-shaped segments may be moved from the conveyor to the wrapper conveyor. The gap between the rod-shaped segments may be maintained when the rod-shaped segments are moved to the wrapper conveyor.

The apparatus may comprise a contact element. The contact element may have a counter surface. The counter surface may be arranged at a distance to the support surface of the conveyor or a circumferential surface of the wrapper conveyor.

The counter surface may be adapted to facilitate rotating the rod-shaped segments of the aerosol-generating article around their respective axes.

The counter surface may be adapted to facilitate wrapping a bridging element, in particular a sheet, around the rod-shaped segments of the aerosol-generating article. The bridging element may be attached to the rod-shaped segments by an adhesive. The bridging element may facilitate keeping the gap between the rod-shaped segments.

The spacer may be arranged outside of the conveyor. In the retracted position, the spacer may be in a distance from the support surface. In an active position, the spacer may be arranged closer to the support surface than in the retracted position.

The conveyor may be configured to transport the rod-shaped segments along a transport direction. The rod-shaped segments may be arrange inclined, in particular orthogonal, with respect to the transport direction.

The conveyor may comprise a drum adapted to rotate around a rotation axis, extending in a longitudinal direction. The drum may comprise a plurality of grooves formed on the support surface. The grooves may be adapted to receive the rod-shaped segments. The grooves may extend predominantly in the longitudinal direction.

The rod-shaped segments may be transported by the conveyor, in particular on a support surface of the conveyor. The rod-shaped segments may be transported in a transport direction. The rod-shaped segments may be transported along a transport path, in particular circumferentially around a drum. The transport direction may vary along the transport path. The transport direction may be parallel to the tangential direction of the conveyor, in particular the drum. The conveyor may be configured to transport the rod-shaped segments along the transport path. The conveyor may be configured to transport the rod-shaped segments in the transport direction. The rod-shaped segments may be arranged substantially orthogonal with respect to the transport direction. In particular, the rod-shaped segments may predominantly extend in a primary direction. The primary direction may be substantially orthogonal to the transport direction. The conveyor may be configured to support, in particular hold, the rod-shaped segments that are arranged substantially orthogonal to the transport direction.

The rod-shaped segments in the paragraphs above may refer to the first rod-shaped segment and the second rod-shaped segment. The rod-shaped segments in this paragraph may refer to the first rod-shaped segment, the second rod-shaped segment and the third rod-shaped segment.

According to a second aspect of the invention, there is provided a method for manufacturing an aerosol-generating article, in particular assembling an aerosol-generating article. A first rod-shaped segment is provided. A second rod-shaped segment is provided. The first rod-shaped segment and the second rod-shaped segment are axially aligned. A spacer is arranged in between the first rod-shaped segment and the second rod-shaped segment. The spacer is removed, such that a predefined distance is established in between the first rod-shaped segment and the second rod-shaped segment. The first rod-shaped segment and the second rod-shaped segment are connected with a bridging element, such that a gap of the predefined distance is provided in between the first rod-shaped segment and the second rod-shaped segment.

The rod-shaped segments may be transported along a transport direction. The rod-shaped segments may be arranged inclined, in particular orthogonal, with respect to the transport direction.

The conveyor may comprise a drum adapted to rotate around a rotation axis, extending in a longitudinal direction. The drum may comprise a plurality of grooves formed on the support surface. The grooves may be adapted to receive the rod-shaped segments. The grooves may extend predominantly in the longitudinal direction. The rod-shaped segments may be placed in the grooves. The rod-shaped segments may be axially arranged in the grooves.

The first rod-shaped segment and the second rod-shaped segment may be axially aligned on a conveyor, in particular on a support surface of the conveyor. The spacer may be part of a conveyor, in particular the conveyor on which the rod-shaped segments are aligned on. The rod-shaped segments may be transported by the conveyor, in particular on a support surface of the conveyor. The rod-shaped segments may be transported in a transport direction. The rod-shaped segments may be transported along a transport path, in particular circumferentially around a drum. The transport direction may vary along the transport path. The transport direction may be parallel to the tangential direction of the conveyor, in particular the drum. The rod-shaped segments may be arranged substantially orthogonal with respect to the transport direction. In particular, the rod-shaped segments may predominantly extend in a primary direction. The primary direction may be substantially orthogonal to the transport direction.

The rod-shaped segments in this paragraph may refer to the first rod-shaped segment and the second rod-shaped segment. The rod-shaped segments in the paragraphs above may refer to the first rod-shaped segment, the second rod-shaped segment and the third rod-shaped segment.

The first rod-shaped segment or the second rod shaped segment may be pushed against the spacer, in particular by means of a plunger, a guide surface or air pressure. The first rod-shaped segment and the second rod shaped segment may be pushed against the spacer, in particular by means of one or more plungers, one or more guide surfaces or air pressure.

The first-rod shaped segment may be provided by means of air pressure, vacuum or a cam. The second-rod shaped segment may be provided by means of air pressure, vacuum or a cam.

The first rod-shaped segment may be an aerosol-generating rod. The aerosol-generating rod may comprise an aerosol-generating substrate. The aerosol-generating substrate may be tobacco, herbs, oil or an artificial substrate. The second rod-shaped segment may be a filter or hollow tube, in particular made of acetate tow, such as a cigarette filter. The filter may be made of any filtration material, in particular including polymer-free materials. The filter may contain a flavor, in particular menthol.

The first rod-shaped segment and the second rod-shaped segment may be axially aligned.

In the step of aligning the first rod-shaped segment and the second rod-shaped segment, the first rod-shaped segment may be placed on a support surface of a conveyor, in particular in a groove on the support surface of the conveyor. Then, the spacer may be moved to a protruding position adjacent to the first rod-shaped segment. Then, the second rod-shaped segment may be placed on the support surface of the conveyor, in particular in the groove formed on the support surface of the conveyor, adjacent to the spacer. The first rod-shaped segment and the second rod-shaped segment may be placed on opposite sides of the spacer. The second rod-shaped segment may be placed on the support surface of the conveyor before the first rod-shaped segment. The spacer may be moved to a protruding position before any of the first rod-shaped segment and the second rod-shaped segment is placed on the support surface.

In the step of removing the spacer, the spacer may be moved to a retracted position.

The gap may have a length of 1 millimeter to 15 millimeters, in particular 1 millimeter to 4 millimeters. The length of the gap may be the distance between the first rod-shaped segment and the second rod-shaped segment. The length of the gap may be measured in a longitudinal direction of the first-rod shaped segment. The longitudinal direction of the first rod-shaped segment may be identical to the longitudinal direction of the second rod-shaped segment.

The second rod-shaped segment may have a length of 7 millimeters to 35 millimeters, in particular 20 millimeters to 30 millimeters, in particular about 27 millimeters.

In the step of connecting the first rod-shaped segment and the second rod-shaped segment with a bridging element, the bridging element may be attached to both the first rod-shaped segment and the second rod-shaped segment. The bridging element may be wrapped around the first rod-shaped segment and the second rod-shaped segment. The first rod-shaped segment and the second rod-shaped segment may be rotated, such that the bridging element may be wrapped around the first rod-shaped segment and the second rod-shaped segment. The first rod-shaped segment and the second rod-shaped segment may remain stationary and the bridging element may be wrapped around the first rod-shaped segment and the second rod-shaped segment.

The bridging element may be a wrapper, in particular a sheet. The bridging element may be attached to the first rod-shaped segment and the second rod-shaped segment by means of an adhesive. The adhesive may be applied to an inner surface of the bridging element. The inner surface of the bridging element may get in contact with the rod-shaped segments.

The bridging element may have a thickness of 20 micrometers to 140 micrometers, in particular about 30 micrometers.

The bridging element may be a sheet, in particular a paper sheet. The bridging element may consist of multiple parts, in particular a first sheet and a second sheet.

The bridging element may extend along between 1 millimeter and 15 millimeters of the length of the first rod-shaped segment. Such a length may be sufficient to attach the first rod-shaped segment to the second rod-shaped segment. The bridging element may extend along the entire length of the first rod-shaped segment. The bridging element may extend along the entire length of the second rod-shaped segment.

The bridging element may comprise at least one of a cellulose based material, paper, cardboard, reconstituted tobacco or a cellulose based film.

The bridging element may have a weight of 50 grams per square meter or greater. The bridging element may improve the strength of the aerosol-generating article. The bridging article may prevent the gap between the first rod-shaped segment and the second rod-shaped segment from collapsing, in particular during use and during the manufacture of the aerosol-generating article.

The first rod-shaped segment and the second rod-shaped segment may be axially aligned in a groove formed on a support surface of a conveyor, in particular a drum. Aligning the segments in a groove may facilitate aligning the segments, may facilitate holding the segments or may facilitate conveying the segments.

The first rod-shaped segment and the second rod-shaped segment may be kept in the groove by means of suction. The suction may be applied through suction holes in the support surface of the conveyor. Suction holes may also be located outside of the groove. In a conveyor without grooves, the suction holes may be located in the support surface.

The method may further comprise the step of providing a third rod-shaped segment. The second rod-shaped segment may be arranged between the first rod-shaped segment and the third rod-shaped segment. The spacer may be provided between the first rod-shaped segment and the second rod-shaped segment. A second spacer may be provided between the second rod-shaped segment and the third rod-shaped segment. The two spacers may be removed, such that a gap of the predefined distance may be established between the first rod-shaped segment and the second rod-shaped segment and a second gap of a second predefined distance may be established between the second rod-shaped segment and the third rod-shaped segment. The first rod-shaped segment, the second rod-shaped segment and the third rod-shaped segment may be connected by wrapping with the bridging element.

The second predefined distance may be identical to the predefined distance. The second spacer may be identical to the spacer.

Such a method may provide two aerosol-generating articles at the same time. This may result in higher efficiency and higher throughput.

The bridging element may be wrapped around the first rod-shaped segment, the second rod-shaped segment and the third rod-shaped segment.

The third rod-shaped segment may be a rod comprising an aerosol-generating substrate. The third rod-shaped segment may be identical to the first rod-shaped segment.

The method may further comprise the step of cutting through the bridging element and the second rod-shaped segment. This may result in two, in particular substantially identical, aerosol-generating articles being formed.

One of the two aerosol-generating articles may be rotated by 180 degrees, such that the two aerosol-generating articles may be oriented in the same direction. The rotation may be performed with respect to a rotation axis orthogonal to a longitudinal axis of the aerosol-generating article that is rotated. This means that the first rod-shaped segment in a first aerosol-generating article is on the same side as the third rod-shaped segment in a second aerosol-generating article.

According to a third aspect of the invention, there is provided a use of a spacer in an apparatus for manufacturing an aerosol-generating article to establish a predefined gap between an aerosol-generating substrate segment and a filter segment. The spacer may in particular be used in an apparatus for assembling an aerosol-generating article.

The spacer may be part of a conveyor. The conveyor may comprise a drum. The conveyor may transport the aerosol-generating substrate segment and the filter segment. The aerosol-generating substrate segment and the filter segment may be arranged, in particular aligned, on a support surface of a conveyor, in particular the conveyor that comprises the spacer.

The conveyor may transport the aerosol-generating substrate segment and the filter segment in a transport direction. The aerosol-generating substrate segment and the filter segment may be arranged substantially orthogonal to the transport direction. The aerosol-generating substrate segment and the filter segment may extend predominantly in a primary direction. The primary direction may be substantially orthogonal to the transport direction.

The conveyor may comprise a drum adapted to rotate around a rotation axis, extending in a longitudinal direction. The drum may comprise a plurality of grooves formed on the support surface. The grooves may be adapted to receive the rod-shaped segments. The grooves may extend predominantly in the longitudinal direction.

The apparatus according to the first aspect of the invention may be used using method steps of the method according to the second aspect of the invention. The method according to the second aspect of the invention may be performed with an apparatus according to the first aspect of the invention. The use of a spacer in an apparatus for manufacturing an aerosol-generating article according to the third aspect of the invention may be performed with an apparatus according to the first aspect of the invention or by using method steps of the method according to the second aspect of the invention.

The invention is defined in the claims. However, below there is provided a non-exhaustive list of non-limiting examples. Any one or more of the features of these examples may be combined with any one or more features of another example, embodiment, or aspect described herein.

Example Ex1: An apparatus, for example, an apparatus for assembling an aerosol-generating article, comprising a conveyor with a support surface for supporting at least two axially aligned rod-shaped segments of the aerosol-generating article, and a spacer, wherein the apparatus is configured to move the spacer from a retracted position to an active position, in which the spacer provides an abutment means for the rod-shaped segments on the support surface.

Example Ex2: An apparatus, for example, an apparatus for assembling an aerosol-generating article, according to example Ex1, comprising several aligned spacers, wherein the several aligned spacers may be alternatingly arranged with several axially aligned rod-shaped segments.

Example Ex3: An apparatus, for example, an apparatus for assembling an aerosol-generating article, according to example Ex1 or Ex2, wherein the conveyor comprises the spacer, in particular the conveyor comprises a storing cavity to house the spacer, at least when the spacer is in the retracted position.

Example Ex4: An apparatus, for example, an apparatus for assembling an aerosol-generating article, according to any one of the previous examples, wherein, in the retraced position, the spacer is flush with or retracted below the support surface, and, in the active position, the spacer protrudes from the support surface.

Example Ex5: An apparatus, for example, an apparatus for assembling an aerosol-generating article, according to any one of the previous examples, wherein a plunger or guide surface is provided to push one or both rod-shaped segments against the spacer in the active position.

Example Ex6: An apparatus, for example, an apparatus for assembling an aerosol-generating article, according to any one of the previous examples, wherein the spacer has a width of 1 millimeter to 15 millimeters, in particular 1 millimeter to 4 millimeters.

Example Ex7: An apparatus, for example, an apparatus for assembling an aerosol-generating article, according to any one of the previous examples, wherein the conveyor comprises a cam, wherein the cam is adapted to move the spacer from the retracted position to the active position.

Example Ex8: An apparatus, for example, an apparatus for assembling an aerosol-generating article, according to any one of the previous examples, wherein the conveyor comprises a drum adapted to rotate around a rotation axis.

Example Ex9: An apparatus, for example, an apparatus for assembling an aerosol-generating article, according example Ex8, wherein the drum comprises the spacer and the drum is adapted to rotate relative to the cam, such that the spacer is rotated around the cam.

Example Ex10: An apparatus, for example, an apparatus for assembling an aerosol-generating article, according to any one of examples Ex7 to Ex9, wherein the cam is stationary.

Example Ex11: An apparatus, for example, an apparatus for assembling an aerosol-generating article, according to any one of examples Ex7 to Ex10, wherein the cam is a desmodromic cam.

Example Ex12: An apparatus, for example, an apparatus for assembling an aerosol-generating article, according to any one of examples Ex7 to Ex11, wherein the cam is a magnetic cam.

Example Ex13: An apparatus, for example, an apparatus for assembling an aerosol-generating article, according to any one of examples Ex8 to Ex12, wherein the drum is stationary and the cam is adapted to rotate relative to the drum.

Example Ex14: An apparatus, for example, an apparatus for assembling an aerosol-generating article, according to any one of examples Ex8 to Ex13, wherein the drum is adapted to rotate around a rotation axis and the cam is adapted to rotate around a rotation axis, in particular around the same rotation axis as the drum.

Example Ex15: An apparatus, for example, an apparatus for assembling an aerosol-generating article, according to any one of the previous examples, wherein the conveyor comprises a groove forming the support surface, wherein the groove is adapted to receive the rod-shaped segments of the aerosol-generating article.

Example Ex16: An apparatus, for example, an apparatus for assembling an aerosol-generating article, according to example Ex15, wherein the spacer is arranged such that the spacer protrudes into the groove in the active position.

Example Ex17: An apparatus, for example, an apparatus for assembling an aerosol-generating article, according to any example Ex15 or Ex16, wherein the storing cavity opens towards the groove.

Example Ex18: An apparatus, for example, an apparatus for assembling an aerosol-generating article, according to any one examples Ex15 to Ex17, wherein the conveyor comprises multiple grooves, in particular spaced around a circumferential surface of the conveyor.

Example Ex19: An apparatus, for example, an apparatus for assembling an aerosol-generating article, according to any one of the previous examples, wherein the conveyor comprises multiple spacers.

Example Ex20: An apparatus, for example, an apparatus for assembling an aerosol-generating article, according to any one of the previous examples, further comprising a spring, wherein the spring is adapted to bias the spacer towards the retracted position.

Example Ex21: An apparatus, for example, an apparatus for assembling an aerosol-generating article, according to example Ex20, wherein the spacer comprises a flange adapted to engage with the spring.

Example Ex22: An apparatus, for example, an apparatus for assembling an aerosol-generating article, according to example Ex20 or Ex21, wherein the spring is a compression spring arranged between a part of the spacer and the support surface.

Example Ex23: An apparatus, for example, an apparatus for assembling an aerosol-generating article, according to example Ex20 or Ex21, wherein the spring is a tension spring arranged between a part of the spacer and a center of the conveyor.

Example Ex24: An apparatus, for example, an apparatus for assembling an aerosol-generating article, according to any one of the previous examples, wherein the apparatus comprises magnets, wherein the magnets are adapted to bias the spacer towards the retracted position.

Example Ex25: An apparatus, for example, an apparatus for assembling an aerosol-generating article, according to any one of the previous examples, wherein suction holes are provided in the support surface.

Example Ex26: An apparatus, for example, an apparatus for assembling an aerosol-generating article, according to example Ex25, wherein the suction holes are provided in the groove on the support surface.

Example E27: An apparatus, for example, an apparatus for assembling an aerosol-generating article, according to any one of the previous examples, further comprising a wrapper conveyor, in particular a drum adapted to rotate around a rotation axis.

Example Ex28: An apparatus, for example, an apparatus for assembling an aerosol-generating article, according to example Ex27, wherein the wrapper conveyor is arranged adjacent to the conveyor.

Example Ex29: An apparatus, for example, an apparatus for assembling an aerosol-generating article, according to any one of the previous examples, further comprising a contact element with a counter surface, wherein the counter surface is arranged at a distance to the support surface of the conveyor or a circumferential surface of the wrapper conveyor.

Example Ex30: An apparatus, for example, an apparatus for assembling an aerosol-generating article, according to example Ex29, wherein the counter surface is adapted to facilitate rotating the rod-shaped segments of the aerosol-generating article around their respective axes.

Example Ex31: An apparatus, for example, an apparatus for assembling an aerosol-generating article, according to example Ex29 or Ex30, wherein the counter surface is adapted to facilitate wrapping a bridging element, in particular a sheet, around the rod-shaped segments of the aerosol-generating article.

Example Ex32: An apparatus, for example, an apparatus for assembling an aerosol-generating article, according to any one of the previous examples, wherever appropriate, wherein the spacer is arranged outside of the conveyor, wherein in the retracted position, the spacer is in a distance from the support surface, and in the active position, the spacer is arranged closer to the support surface than in the retracted position.

Example Ex33: A method, for example, a method for manufacturing an aerosol-generating article, comprising the steps of providing a first rod-shaped segment, providing a second rod-shaped segment, axially aligning the first rod-shaped segment and the second rod-shaped segment, arranging a spacer in between the first rod-shaped segment and the second rod-shaped segment, removing the spacer, wherein a predefined distance is established in between the first rod-shaped segment and the second rod-shaped segment, and connecting the first rod-shaped segment and the second rod-shaped segment with a bridging element, such that a gap of the predefined distance is provided in between the first rod-shaped segment and the second rod-shaped segment.

Example Ex34: A method, for example, a method for manufacturing an aerosol-generating article, according to example Ex33, wherein the first rod-shaped segment is a rod comprising an aerosol-generating substrate.

Example Ex35: A method, for example, a method for manufacturing an aerosol-generating article, according to example Ex33 or Ex34, wherein the second rod-shaped segment is a filter.

Example Ex36: A method, for example, a method for manufacturing an aerosol-generating article, according to any one of examples Ex33 to Ex35, wherein the first rod-shaped segment and the second rod-shaped segment are axially aligned.

Example Ex37: A method, for example, a method for manufacturing an aerosol-generating article, according to any one of examples Ex33 to Ex36, wherein the step of connecting the first rod-shaped segment and second rod-shaped segment with a bridging element comprises attaching the bridging element to both the first rod-shaped segment and the second rod-shaped segment, and rotating the first rod-shaped segment and the second rod-shaped segment, thereby wrapping the bridging element around the first rod-shaped segment and the second rod-shaped segment.

Example Ex38: A method, for example, a method for manufacturing an aerosol-generating article, according to any one of examples Ex33 to Ex37, wherein the step of axially aligning the first rod-shaped segment and the second rod-shaped segment comprises placing the first rod-shaped segment on a support surface of a conveyor, in particular in a groove formed on the support surface of the conveyor, moving the spacer to a protruding position adjacent to the first rod-shaped segment, and placing the second rod-shaped segment on the support surface of the conveyor, in particular in the groove formed on the support surface of the conveyor, adjacent to the spacer, wherein the first rod-shaped segment and the second rod-shaped segment are placed on opposite sides of the spacer.

Example Ex39: A method, for example, a method for manufacturing an aerosol-generating article, according to any one of examples Ex33 to Ex38, wherein the step of removing the spacer comprises moving the spacer to a retracted position.

Example Ex40: A method, for example, a method for manufacturing an aerosol-generating article, according to any one of examples Ex33 to Ex39, wherein the gap has a length of 1 millimeter to 15 millimeters, in particular 1 millimeter to 4 millimeters.

Example Ex41: A method, for example, a method for manufacturing an aerosol-generating article, according to any one of examples Ex33 to Ex40, wherein the second rod-shaped segment has a length of 7 millimeters to 35 millimeters, in particular 20 millimeters to 30 millimeters, in particular about 27 millimeters.

Example Ex42: A method, for example, a method for manufacturing an aerosol-generating article, according to any one of examples Ex33 to Ex41, wherein the bridging element is a wrapper.

Example Ex43: A method, for example, a method for manufacturing an aerosol-generating article, according to any one of examples Ex33 to Ex42, wherein the bridging element is wrapped around the first rod-shaped segment and the second rod-shaped segment.

Example Ex44: A method, for example, a method for manufacturing an aerosol-generating article, according to any one of examples Ex33 to Ex43, wherein the bridging element is attached to the first rod-shaped segment and the second rod-shaped segment by means of an adhesive.

Example Ex45: A method, for example, a method for manufacturing an aerosol-generating article, according to any one of examples Ex33 to Ex44, wherein the bridging element has a thickness of 20 micrometers to 140 micrometers, in particular about 30 micrometers.

Example Ex46: A method, for example, a method for manufacturing an aerosol-generating article, according to any one of examples Ex33 to Ex45, wherein the bridging element is a sheet, in particular a paper sheet.

Example Ex47: A method, for example, a method for manufacturing an aerosol-generating article, according to any one of examples Ex33 to Ex46, wherein the bridging element consists of multiple parts, in particular a first sheet and a second sheet.

Example Ex48: A method, for example, a method for manufacturing an aerosol-generating article, according to any one of examples Ex33 to Ex47, wherein the bridging element extends along between 1 millimeter and 15 millimeters of the length of the first rod-shaped segment.

Example Ex49: A method, for example, a method for manufacturing an aerosol-generating article, according to any one of examples Ex33 to Ex48, wherein the bridging element extends along the entire length of the second rod-shaped segment.

Example Ex50: A method, for example, a method for manufacturing an aerosol-generating article, according to any one of examples Ex33 to Ex49, wherein the bridging element comprises at least one of a cellulose based material, paper, cardboard, reconstituted tobacco or a cellulose based film.

Example Ex51: A method, for example, a method for manufacturing an aerosol-generating article, according to any one of examples Ex33 to Ex50, wherein the first rod-shaped segment and the second rod-shaped segment are axially aligned in a groove formed on a support surface of a conveyor, in particular a drum.

Example Ex52: A method, for example, a method for manufacturing an aerosol-generating article, according to example Ex51, wherein the first rod-shaped segment and the second rod-shaped segment are kept in the groove by means of suction, in particular applied through suction holes in the support surface of the conveyor.

Example Ex53: A method, for example, a method for manufacturing an aerosol-generating article, according to any one of examples Ex33 to Ex52, wherein a third rod-shaped segment is provided and the second rod-shaped segment is arranged between the first rod-shaped segment and the third rod-shaped segment, wherein the spacer is provided between the first rod-shaped segment and the second rod-shaped segment and a second spacer is provided between the second rod-shaped segment and the third rod-shaped segment, wherein the two spacers are removed, such that a gap of the predefined distance is established between the first rod-shaped segment and the second rod-shaped segment and a second gap of a second predefined distance is established between the second rod-shaped segment and the third rod-shaped segment, wherein the first rod-shaped segment, the second rod-shaped segment and the third rod-shaped segment are connected by wrapping with the bridging element.

Example Ex54: A method, for example, a method for manufacturing an aerosol-generating article, according to any one of examples Ex33 to Ex53, wherein the bridging element is wrapped around the first rod-shaped segment, the second rod-shaped segment and the third rod-shaped segment.

Example Ex55: A method, for example, a method for manufacturing an aerosol-generating article, according to any one of examples Ex33 to Ex54, wherein the third rod-shaped segment is a rod comprising an aerosol-generating substrate, in particular the third rod-shaped segment is equivalent to the first rod-shaped segment.

Example Ex56: A method, for example, a method for manufacturing an aerosol-generating article, according to any one of examples Ex33 to Ex55, wherein the method further comprises the step of cutting through the bridging element and the second rod-shaped segment, in particular such that two, in particular substantially uniform, aerosol-generating articles are formed.

Example Ex57: A method, for example, a method for manufacturing an aerosol-generating article, according to any one of examples Ex33 to Ex56, wherein one of the two aerosol-generating articles is rotated by 180 degrees, such that the two aerosol-generating articles are oriented in the same direction.

Example Ex58: Use of a spacer in an apparatus for manufacturing an aerosol-generating article to establish a predefined gap between an aerosol-generating substrate segment, and a filter segment.

Example Ex59: Use of a spacer according to example Ex58, wherein the spacer is part of a conveyor, in particular a drum.

The examples will now be further described with reference to the figures.

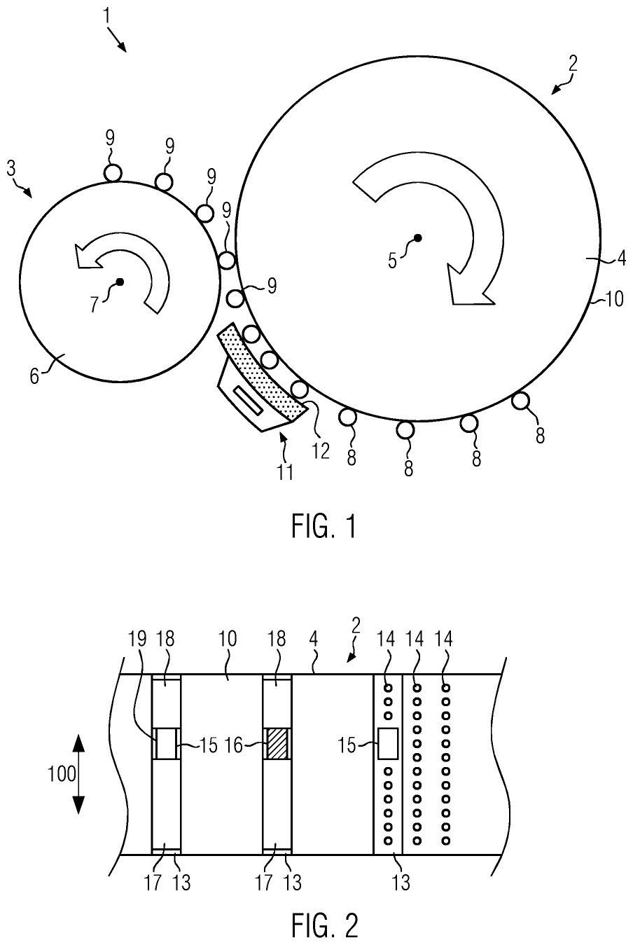

FIG. 1 shows a schematic view of an apparatus according to an embodiment of the invention.

FIG. 2 shows a plan view onto the circumferential surface of the conveyor shown on the right side of FIG. 1.

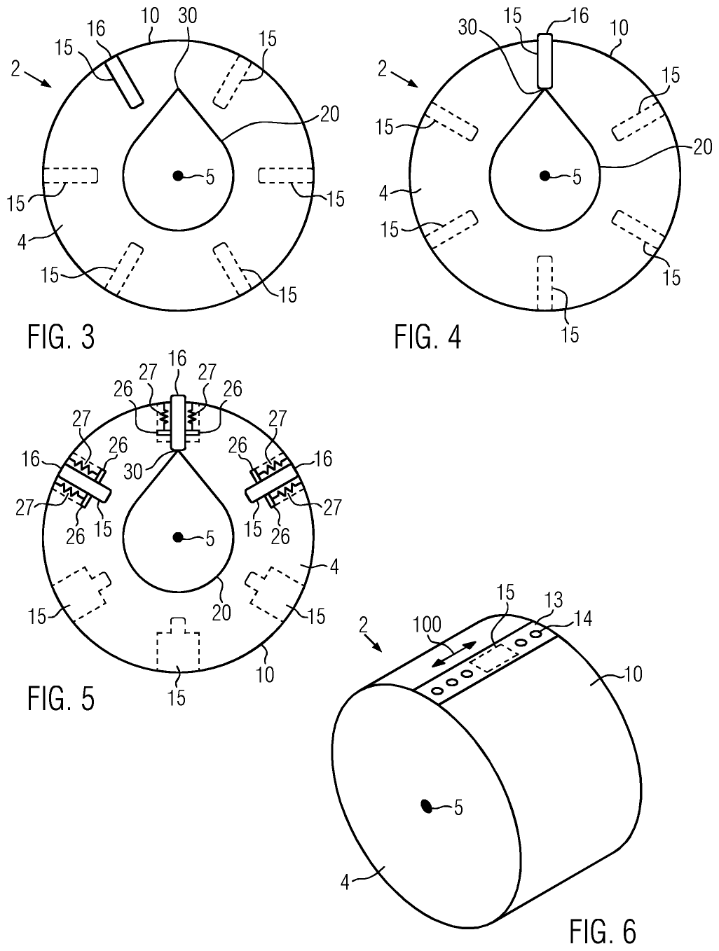

FIG. 3 shows a cross-sectional view of a schematic representation of a conveyor according to an embodiment of the invention.

FIG. 4 shows a cross-sectional view of the conveyor of FIG. 3, but in a different position.

FIG. 5 shows a cross-sectional view of another embodiment of the conveyor shown in FIGS. 3 and 4.

FIG. 6-10 show perspective views of a schematic representation of a conveyor according to an embodiment of the invention and how aerosol-generating articles are manufactured according to an embodiment of the invention.

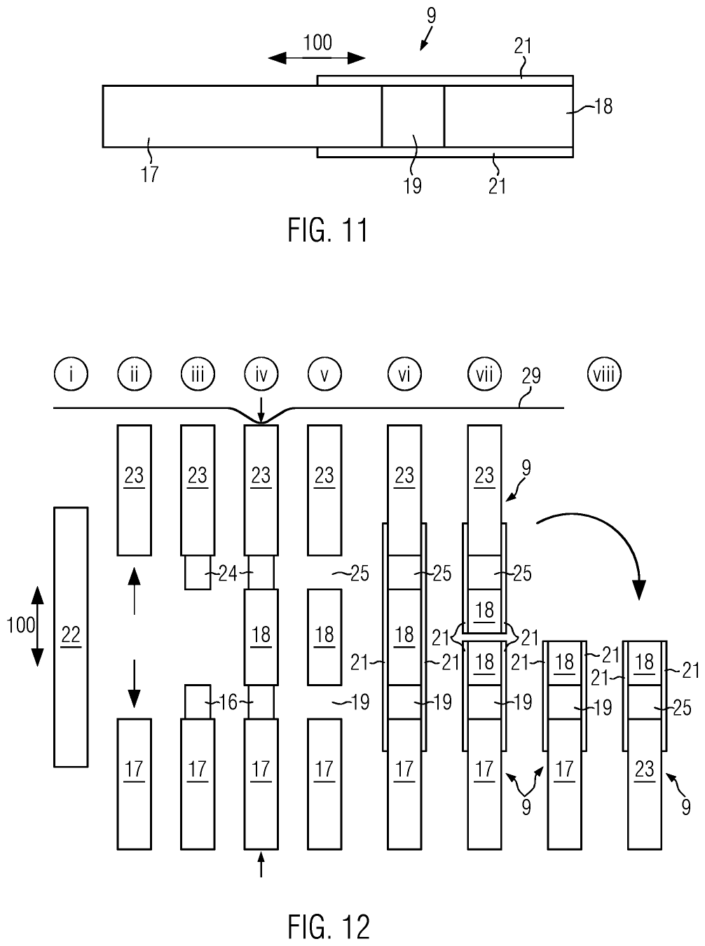

FIG. 11 is a cross-sectional view of an aerosol-generating article manufactured according to an embodiment of the invention.

FIG. 12 is a schematic representation of how aerosol-generating articles are manufactured according to an embodiment of the invention.

An apparatus 1 according to an embodiment of the invention is shown in FIG. 1. The apparatus 1 comprises a conveyor 2 and an auxiliary conveyor 3. The conveyor 2 comprises a drum 4 adapted to rotate around a rotation axis 5, extending in a longitudinal direction 100. The auxiliary conveyor 3 comprises a second drum 6 adapted to rotate around a second rotation axis 7, extending in the longitudinal direction 100. The two drums 4, 6 rotate in different directions. The conveyor 2 is adapted to wrap a bridging element 21 (not shown in FIG. 1) around rod-shaped segments 8 to form aerosol-generating articles 9. The conveyor 2, in particular the drum 4, comprises a support surface 10. The support surface 10 is adapted to support and hold the rod-shaped segments 8 and the aerosol-generating articles 9.

The apparatus 2 further comprises a contact element 11 with a counter surface 12. The counter surface 12 facilitates wrapping the bridging element 21 around the rod-shaped segments 8 to form the aerosol-generating articles 9.

FIG. 2 shows a plan view onto the support surface 10 of the conveyor 2. The conveyor 2, in particular the drum 4, comprises a plurality of grooves 13 formed on the support surface 10. The grooves 13 extend predominantly in the longitudinal direction 100 and are adapted to receive the rod-shaped segments 8. The grooves 13 are equidistantly spaced around the support surface 10 of the drum 4. Suction holes 14 are provided in the support surface 10 in the region of the grooves 13. The suction holes 14 may also be provided outside of the grooves 13, as indicated on the right side of FIG. 2. The suction holes 14 are adapted to facilitate holding the rod-shaped segments 8 and the aerosol-generating articles 9.

The conveyor 2 further comprises storing cavities 15. The storing cavities 15 open towards the grooves 13 and house spacers 16. In each groove 13, one storing cavity 15 is arranged. Each storing cavity 15 houses one spacer 16. The storing cavity 15 is arranged between the suction holes 14 in the groove 13. The spacers 16 can be moved from a retracted position, in which the respective spacer 16 is flush with the support surface 10, as indicated in the groove 13 on the right side of FIG. 2, to an active position, in which the spacer 16 protrudes from the support surface 10, as indicated in the groove 13 in the center of FIG. 2.

In the embodiment shown in FIG. 2, the rod-shaped segments 8 comprise a first rod-shaped segment 17 and a second rod-shaped segment 18. In the active position, the spacer 16 is arranged between the first rod-shaped segment 17 and the second rod-shaped segment 18. On the left side of FIG. 2, the spacer 16 is in the retracted position to establish a gap 19 between the first rod-shaped segment 17 and the second rod-shaped segment 18.

FIGS. 3 and 4 demonstrate how the spacer 16 is moved from the retracted position to the active position. Multiple storing cavities 15 are spaced around the support surface 10 of the drum 4. Each support cavity 15 houses a spacer 16. For simplicity, only one spacer 16 is shown in FIGS. 3 and 4. The conveyor 2 further comprises a cam 20. The cam 20 is stationary, whereas the drum 4 is rotated around the rotation axis 5. Thus, the storing cavities 15 and the spacers 16 are rotated around the cam 20.

In FIG. 3, the spacer 16 is in the retracted position. When the storing cavity 15 with the spacer 16 is aligned with the cam 20, the spacer 16 gets into contact with a distal end 30 of the cam 20 and is partially pushed out of the storing cavity 15 into the active position. In the active position, the spacer 16 protrudes from the support surface 10, as shown in FIG. 4.

FIG. 5 illustrates how the spacer 16 is moved back to the retracted position according to an embodiment of the invention. The spacer 16 comprises two flanges 26 that protrude laterally from the spacer 16. Springs 27 are arranged between the flanges 26 and the support surface 10. The storing cavities 15 of FIG. 5 are bigger compared to the storing cavities 15 in FIGS. 3 and 4 to provide space for the flanges 26 and the springs 27. The springs 27 bias the spacers 16 into the storing cavities 15 towards the retracted position, as illustrated in the top-left part of FIG. 5. When a spacer 16 is moved towards the distal end 30 of the cam 20, the distal end 30 of the cam 20 pushes the spacer 16 partially out of the storing cavity 15 against the biasing force of the springs 27 into the active position. The spacer 16 then protrudes from the supporting surface 10, as illustrated in the top-center part of FIG. 5. When the spacer 16 is moved away from the distal end 30 of the cam 20, the distal end 30 is no longer in contact with the spacer 16, such that the springs 27 push the spacer 16 back into the receiving cavity 15 into the retracted position, as illustrated in the top-right part of FIG. 5.

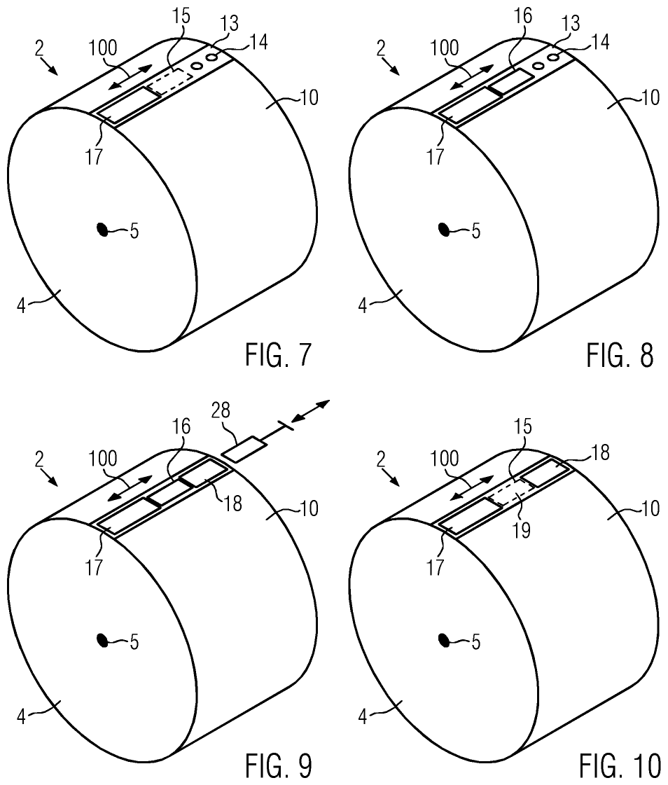

FIGS. 6 to 10 show a schematic overview of how the aerosol-generating articles 9 are manufactured according to an embodiment of the invention. FIG. 6 shows an empty groove 13 on the support surface 10 of the drum 4 of the conveyor 2. The drum 4 and the groove 13 on the drum 4 extend in the longitudinal direction 100. For illustration purpose, only one groove 13 is shown in FIG. 6. However, the conveyor 2 comprises multiple grooves 13. Suction holes 14 are arranged in the groove 13 and a storing cavity 15 is arranged between the suction holes 14. The storing cavity 15 houses a spacer 16, which is in the retracted position in FIG. 6. A first rod-shaped segment 17 is inserted into the groove 13, as illustrated in FIG. 7. The suction holes 14 help to hold the first rod-shaped segment 17 in the groove 13. Then, the spacer 16 is moved into the active position adjacent to the first rod-shaped segment 17, as shown in FIG. 8. The spacer 16 now protrudes from the support surface 10. As shown in FIG. 9, a second rod-shaped segment 18 is then inserted into the groove 13 adjacent to the spacer 16. The second rod-shaped segment 18 is inserted on the opposite side of the spacer 16 than the first rod-shaped segment 17. The rod-shaped segments 17, 18 may be pushed against the spacer 16, in particular by a plunger 28. In FIG. 9, only one plunger 28 that pushes the second rod-shaped segment 18 against the spacer 16 is shown. However, a second plunger may be arranged on the other side of the drum 4 to push the first rod-shaped segment 17 against the spacer 16. Instead of the plunger 28 or in addition, a guide surface 29 (not shown in FIG. 9) or air pressure may be used to push the rod-shaped segments 17, 18 against the spacer 16. The spacer 16 is then moved back into the retracted position, such that a gap 19 is established between the first rod-shaped segment 17 and the second rod-shaped segment 18, as shown in FIG. 10. The gap 19 has a predefined width, namely the width of the spacer 16. The first rod-shaped segment 17 and the second rod-shaped segment 18 are then wrapped with a bridging element 21 to form an aerosol-generating article 9. In FIGS. 6 to 10, the drum 4 remains stationary. However, the drum 4 may also rotate around a rotation axis, relative to a cam 20 to move the spacer 16 from the retracted position to the active position, as illustrated in FIGS. 3 and 4.

A cross-sectional view of an aerosol-generating article 9 manufactured with a method according to an embodiment of the invention is shown in FIG. 11. The aerosol-generating article 9 extends predominantly in a longitudinal direction 100 and comprises a first rod-shaped segment 17 and a second rod-shaped segment 18. The first rod-shaped segment 17 is arranged at a distance to the second rod-shaped segment 18, such that a gap 19 of a predefined width is established between the two rod-shaped segments 17, 18. The aerosol-generating article 9 further comprises a bridging element 21. The bridging element 21 is wrapped around the first rod-shaped segment 17 and the second rod-shaped segment 18, such that the gap 19 is maintained in the aerosol-generating article 9.

A method for manufacturing an aerosol-generating article 9 according to an embodiment of the invention is shown in FIG. 12. In step i), a rod-shaped material 22 is provided. In step ii), the rod-shaped material 22 is cut into a first rod-shaped segment 17 and a third rod-shaped segment 23. The first rod-shaped segment 17 and the third rod-shaped segment 23 are axially aligned with respect to a longitudinal direction 100 and spaced apart from each other. In step iii), a spacer 16 is then arranged adjacent to the first rod-shaped segment 17, and a second spacer 24 is arranged adjacent to the third rod-shaped segment 23. In step iv), a second rod-shaped segment 18 is inserted between the two spacers 16, 24. Thus, the two aligned spacers 16, 24 are alternatingly arranged with three aligned rod-shaped segments 17, 18, 23. Pressure may be applied from both sides of the assembly, comprising the three rod-shaped segments 17, 18, 23 and the two spacers 16, 24, to arrange the components adjacent to each other. The pressure may be provided by a stationary guide surface 29, which engages the outer end of the first rod-shaped segment 17 or the third rod-shaped segment 23, as indicated by arrows in step iv). The stationary guide surface 29 may extend at least partially along the circumference of the conveyor 2, wherein the stationary guide surface 29 may be inclined with respect to the longitudinal direction 100. A second stationary guide surface (not shown in FIG. 12) may be arranged on the other side of the conveyor 2. As an alternative to a guide surface 29, the force indicated by arrows in step iv) may be provided by a plunger 28 or multiple plungers 28, as shown in FIG. 9. The plunger 28 or plungers 28 may be stationary or may rotate with the drum 4. In step v), the two spacers 16, 24 are removed such that a gap 19 is established between the first rod-shaped segment 17 and the second rod-shaped segment 18, and a second gap is established between the second rod-shaped segment 18 and the third rod-shaped segment 23. In step vi), a bridging element 21 is attached to the first rod-shaped segment 17, the second rod-shaped segment 18 and the third rod-shaped segment 23, and wrapped around these three rod-shaped segments 17, 18, 23. The bridging element 21 helps to maintain the gap 19 between the first rod-shaped segment 17 and the second rod-shaped segment 18, and the second gap 25 between the second rod-shaped segment 18 and the third rod-shaped segment 23. In step vii), a cut is made through the bridging element 21 and the second rod-shaped segment 18, such that two aerosol-generating articles 9 are formed. The cut is made substantially in the middle of the second rod-shaped segment 18. The aerosol-generating articles 9 extend predominantly in the longitudinal direction 100. In stop viii), one of the two aerosol-generating articles 9 is rotated 180 degrees, such that the two aerosol generating articles 9 are oriented in the same direction. The rotation is performed around a rotation axis that is orthogonal to the longitudinal direction 100 of the aerosol-generating articles 9.

1.-15. (canceled)

16. An apparatus for assembling an aerosol-generating article, the apparatus comprising:
a conveyor with a support surface configured to support at least two axially aligned rod-shaped segments of the aerosol-generating article; and
a spacer,
wherein the apparatus is configured to move the spacer from a retracted position to an active position, in which the spacer provides an abutment means for the rod-shaped segments on the support surface, and
wherein the conveyor comprises the spacer.

17. The apparatus according to claim 16, wherein the conveyor further comprises a storing cavity to house the spacer at least when the spacer is in the retracted position.

18. The apparatus according to claim 16, wherein, in the retraced position, the spacer is flush with or retracted below the support surface, and, in the active position, the spacer protrudes from the support surface.

19. The apparatus according to claim 16,
wherein the conveyor further comprises a cam, and
wherein the cam is configured to move the spacer from the retracted position to the active position.

20. The apparatus according to claim 16, wherein the conveyor further comprises a drum configured to rotate around a rotation axis.

21. The apparatus according to claim 20, wherein the drum comprises the spacer and the drum is further configured to rotate relative to a cam, such that the spacer is rotated around the cam.

22. The apparatus according to claim 16,
wherein the conveyor further comprises a groove forming the support surface, and
wherein the groove is configured to receive the at least two axially aligned rod-shaped segments of the aerosol-generating article.

23. The apparatus according to claim 22, wherein the spacer is arranged such that the spacer protrudes into the groove in the active position.

24. The apparatus according to claim 16, further comprising a spring configured to bias the spacer towards the retracted position.

25. The apparatus according to claim 16, wherein suction holes are provided in the support surface.

26. The apparatus according to claim 16,
wherein the conveyor is configured to transport the at least two axially aligned rod-shaped segments along a transport direction, and
wherein the at least two axially aligned rod-shaped segments are arranged orthogonal with respect to the transport direction.

27. A method for manufacturing an aerosol-generating article, the method comprising the steps of:
providing a first rod-shaped segment;
providing a second rod-shaped segment;
axially aligning the first rod-shaped segment and the second rod-shaped segment on a support surface of a conveyor;
arranging a spacer that is part of the conveyor in between the first rod-shaped segment and the second rod-shaped segment;
removing the spacer, wherein a predefined distance is established in between the first rod-shaped segment and the second rod-shaped segment; and
connecting the first rod-shaped segment and the second rod-shaped segment with a bridging element, such that a gap of the predefined distance is provided in between the first rod-shaped segment and the second rod-shaped segment.

28. The method according to claim 27, wherein the step of connecting the first rod-shaped segment and second rod-shaped segment with a bridging element comprises attaching the bridging element to both the first rod-shaped segment and the second rod-shaped segment, and rotating the first rod-shaped segment and the second rod-shaped segment, thereby wrapping the bridging element around the first rod-shaped segment and the second rod-shaped segment.

29. The method according to claim 27,
further comprising providing a third rod-shaped segment,
wherein the second rod-shaped segment is arranged between the first rod-shaped segment and the third rod-shaped segment,
wherein the spacer is provided between the first rod-shaped segment and the second rod-shaped segment and a second spacer is provided between the second rod-shaped segment and the third rod-shaped segment,
wherein the two spacers are removed, such that a gap of the predefined distance is established between the first rod-shaped segment and the second rod-shaped segment and a second gap of a second predefined distance is established between the second rod-shaped segment and the third rod-shaped segment, and
wherein the first rod-shaped segment, the second rod-shaped segment, and the third rod-shaped segment are connected by wrapping with the bridging element.

30. The apparatus for assembling an aerosol-generating article according to claim 16, further comprising a spacer configured to establish a predefined gap between an aerosol-generating substrate segment and a filter segment, wherein the spacer is part of the conveyor.
